(19) United States
(12) Patent Application Publication
(10) Pub. No.: US 2009/0220325 A1
(43) Pub. Date: Sep. 3, 2009

(54) Tilting Flatbed Trailer for Loading, Transporting, Unloading and Placement of Heavy Field Equipment

(76) Inventors: Jason Eugene Berney, Mansfield, TX (US); Debra Berney, Mansfield, TX (US); Harry Berney, Mansfield, TX (US)

Correspondence Address: Richard J. Steeno, 3114 Summer Grove Ct., Mansfield, TX, 76063, US

(21) Appl. No.: 12/040,906

(22) Filed: Mar. 2, 2008

(51) Int. Cl. B60P 1/22

(52) U.S. Cl. 414/494; 414/469; 414/529; 414/812

(57) ABSTRACT

A system and a method for loading, transporting and unloading large, heavy field equipment to and from nontraditional operational location. The invention discloses a specially designed tilt flatbed trailer, a winch and cabling mounted near the front of the trailer bed, and heavy duty steel rollers imbedded into the flatbed surface. Initially, the trailer is positioned in an upwardly titled angle such that the rear edge of the trailer bed is near ground level next to the lead edge of the equipment. The winch cabling is attached to the equipment and pulls it over the rear edge of the trailer via a larger receiving roller. The equipment is pulled upward and onto the trailer bed until the rear edge of the equipment base clears the ground. The tilt bed is then lowered to a horizontal position. During loading, the equipment moves smoothly onto the trailer surface via the embedded rollers. To unload, the process is reversed.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Although the oil and gas industry has been flourishing and developing for over one hundred and fifty years, innovation and efficiency are still in high demand. Today's oil and gas development operations are a complex matrix of technologies, schedules and operations. Large amounts of capital, both manpower and money, are on-the-line in the attempt to produce valuable oil, gas or both from a well.

Various types of equipment are used during the drilling and production process. Water is an essential resource for mixing drilling mud, cooling equipment and for secondary recovery efforts from existing wells. Large water pumps and similar equipment are routinely dispatched and used for these operations. This equipment type is extremely expensive and heavy. This invention addresses the oil and gas industry's need to pick-up, transport, and place large, heavy field equipment safely and efficiency where and when needed. Water pumps, for example are often transported between wells as needed throughout an active production field.

Conventional heavy trailer equipment and existing designs do not meet the unique needs of the oil and gas industry with regard to large water pumps and similar equipment. Traditional over-the-road trailers are designed to cover large distances over major highways. Conventional trailers are often loaded and unloaded at loading docks designed for such vehicles. Fork lifts, cranes and other industrial lifting devices are typically used to lift and position heavy loads on these trailers.

At an oilfield drilling site, fork lifts, cranes and other lifting devices are absent. At best, these types of equipment are located on site only when the drilling site is just beginning. However, the large water pumps, which are one application of this invention, are needed at different times throughout the life of the well for different reasons.

Though hard to believe, large expensive equipment delivered to field operational sites is often dragged off of and dropped from traditional heavy equipment trailers. Damage to the equipment is routine and the delay in waiting for repairs is also costly. Fork lifts and cranes are routinely rented for the sole purpose of picking up and placing this heavy equipment onto traditional trailers; again wasting time and resources. Additionally, traditional trailer equipment, due to its size and weight, often cannot even come onto a drill site under wet or soft soil conditions, further limiting it's usefulness.

Furthermore, traditional equipment cannot accurately place this heavy equipment at the exact location preferred for operation. Additional time and equipment must be utilized to drag or rotate the equipment to its proper position.

The invention disclosed herein addresses these limitations while doing so in a safer and more efficient manner. The invention disclosed is a trailer system capable of picking up a large heavy piece of equipment from ground level. The system is scaled so that it is strong enough to handle this class of equipment safely and reliably yet compact and maneuverable enough to be able to place and pick up equipment at exact locations.

### BRIEF SUMMARY OF THE INVENTION

The invention disclosed provides a means for overcoming the limitations of conventional equipment trailers described in the Background of the Invention. Specifically, the invention allows for the loading, transportation, unloading and placement of large, heavy field equipment without the need of forklifts, cranes or any additional lifting equipment. The trailer system disclosed features a tilting flatbed surface that lowers the back edge of the trailer to ground level. A wench assembly draws the equipment onto the back of the trailer. The rear edge of the trailer bed is specifically designed to receive the leading edge of the equipment base. Several high strength steel rollers are embedded in the trailer bed's surface to allow the base of the equipment to ‘roll’ up and across the trailer bed to a secure position. Once the equipment rear edge is on the trailer bed surface, the trailer can be tilted back to a horizontal position. The wench is used to draw the pump to a resting position. The pump is secured for transport by chains and straps as is customary in the industry.

To unload the equipment, the process is reversed. The flatbed surface is again raised until the trailing edge is at or near ground level. The winch is then engaged to release and allow the equipment to slowly roll from the trailer surface to ground level in a controlled motion.

At no time during the loading and unloading operation is any equipment dropped or dragged to or from the trailer system. The likelihood of damage is drastically reduced. Additionally, because of the maneuverability and compact design, equipment can be placed in its exact operational location.

### BRIEF DESCRIPTION OF THE SEVERAL VIEWS OF THE DRAWINGS

FIG. 1: The first drawing is an isometric view of the full trailer. This trailer utilizes a goose-neck style hitch and dual tandem axle set.

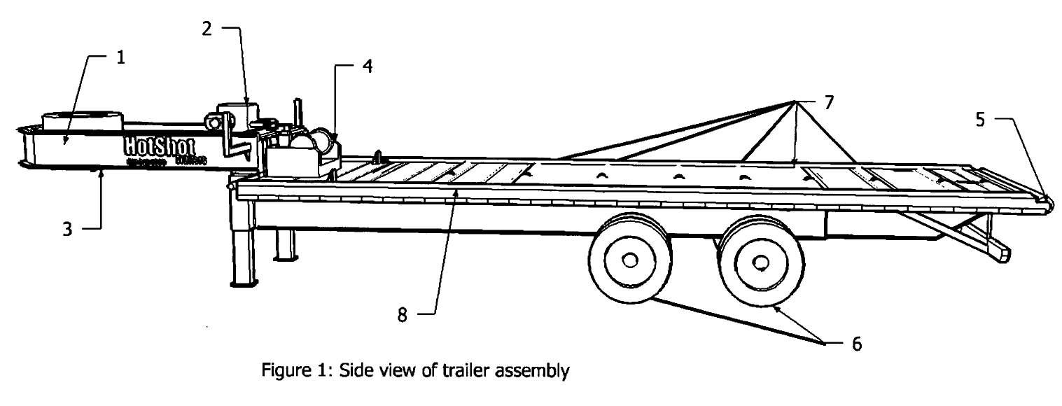

FIG. 2: A side view showing the trailer bed in the titled up position preparing to receive field equipment.

FIG. 3: A closer side view showing equipment at edge of trailer bed. This drawing shows the wench cabling attached to the equipment.

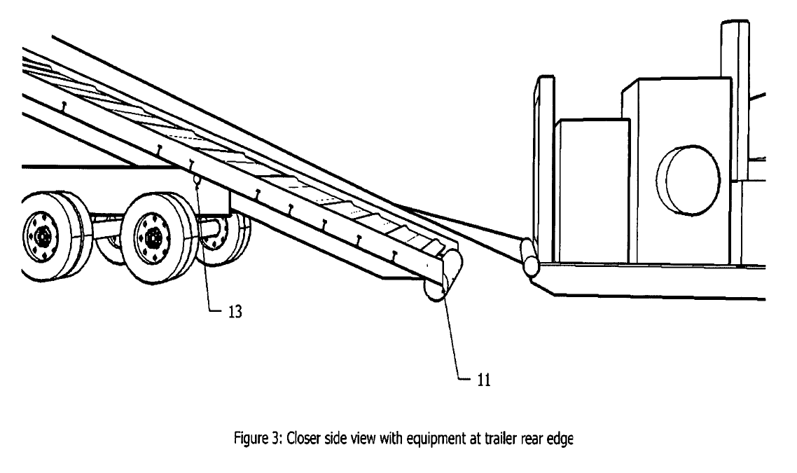

FIG. 4: Side view of trailer as equipment is drawn upward with wench.

FIG. 5: Side view showing equipment clearing ground level.

FIG. 6: Side view showing equipment fully loaded and trailer surface at lowered position.

FIG. 7: Close-up of trailer bed disclosing embedded rollers.

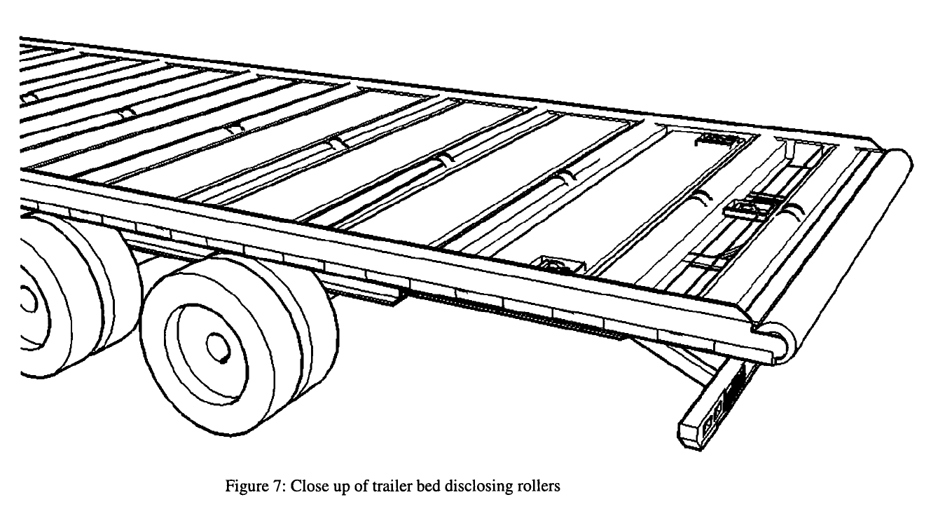

FIG. 8: Trailer bed roller assembly.

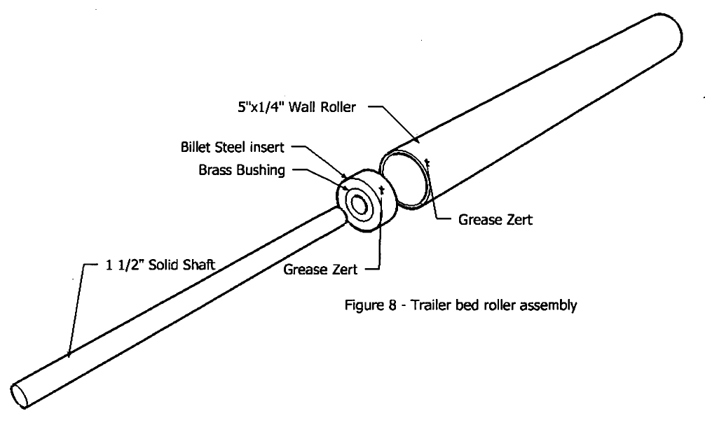

FIG. 9: Close-up of rear edge of trailer.

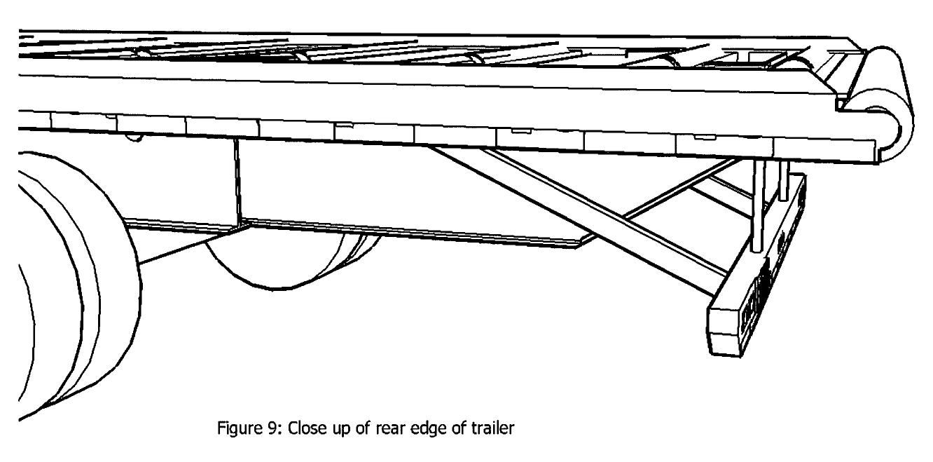

FIG. 10: Isometric view looking forward from the back of the trailer.

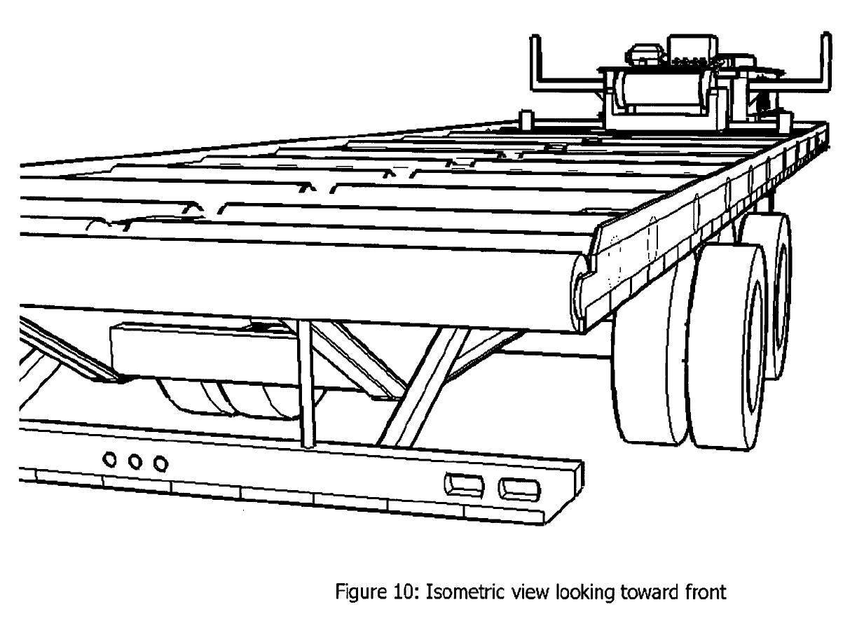

FIG. 11: Wireless remote control unit.

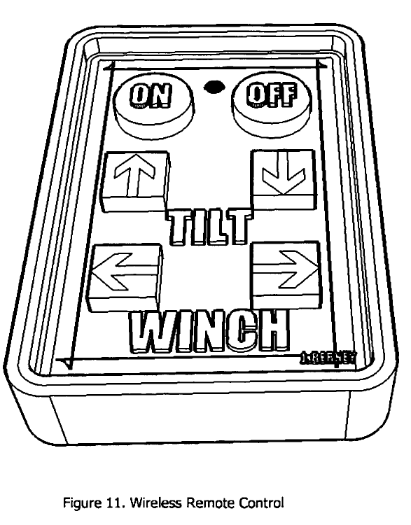

### DETAILED DESCRIPTION OF THE INVENTION

100. The disclosed invention utilizes a goose-neck flatbed trailer 1 configuration as a base. The trailer can be pulled using commercially available 5^{th} wheel hitch 3 assemblies. The present embodiment utilizes a dual tandem axle set 6 and heavy duty spring suspension set.

101. The flatbed portion of the trailer 8 further encompasses a hydraulic tilt system 9 in which the front edge of the trailer bed surface can be raised to an angle sufficient to cause the rear edge of the trailer to rest at or near ground level. A dual hydraulic cylinder 9 raises the forward end of the flatbed base. The trailer bed consists of a double beam design 12 in which the inside beam structure is raised by the hydraulic cylinders. The trailer bed and interior beam structure pivots at a point near and above the rear axle of the trailer 13. The pivot point is accomplished by means of a 2 inch diameter solid steal rod which extends through both interior and exterior beam structures.

102. This design feature overcomes two limitations of existing equipment. First, the tilt bed allows equipment to be loaded from ground level without the need for a crane or forklift. The pivot point is positioned such that the dual axles maintain load bearing forces when the trailer bed is in a tilted position. Second, the equipment can be precisely placed directly from the trailer without any need for additional movement after unloading. Typical of prior art in this area, after this equipment is unloaded additional equipment is need to drag it to an operational location.

103. The tilt flatbed trailer base includes a cable and wench assembly 4 mounted at the forward end used to draw equipment onto the flatbed during loading. The same assembly is used to lower the equipment to ground level during unloading. An embodiment of this feature may utilize an electric or hydraulic winch. This feature is used in conjunction with the tilt bed to load and unload equipment.

104. The tilt flatbed trailer further encompasses a trailer base surface 8 specifically designed for the heavy bulky equipment targeted by the invention. Several heavy duty steel rollers 7 are embedded into the base surface of the trailer. These rollers allow the base of the equipment to ‘roll’ onto and off of the trailer. The rollers are used in conjunction with the tilt flatbed and wench assembly. The rollers are a key feature needed to overcome the limitations of existing trailer equipment. Specifically, the rollers allow an extremely heave piece of equipment to ‘roll’ along the bed of the trailer during loading and unloading. A larger steel roller 5 is attached at the back edge of the trailer to provide a smooth transition from ground level to the trailer surface. Existing trailer equipment examples do not include any embodiment of this feature. Typically, field equipment examples are dragged off the back of non-tilting trailers causing damage on a regular basis.

105. The invention further discloses electronic and hydraulic equipment 2 controlled with a wireless handheld remote FIG. 12. The handheld remote controls both the tilt and winch subsystems. Most heavy equipment trailers today have control levers and/or buttons fixed to the trailer body itself. The invention significantly improves safety and accuracy of operations by allowing the operator to freely move around at a safe distance to view and monitor the loading and unloading of the equipment. The present embodiment of the invention also discloses redundant on-board controls for the winch and tilt operations.

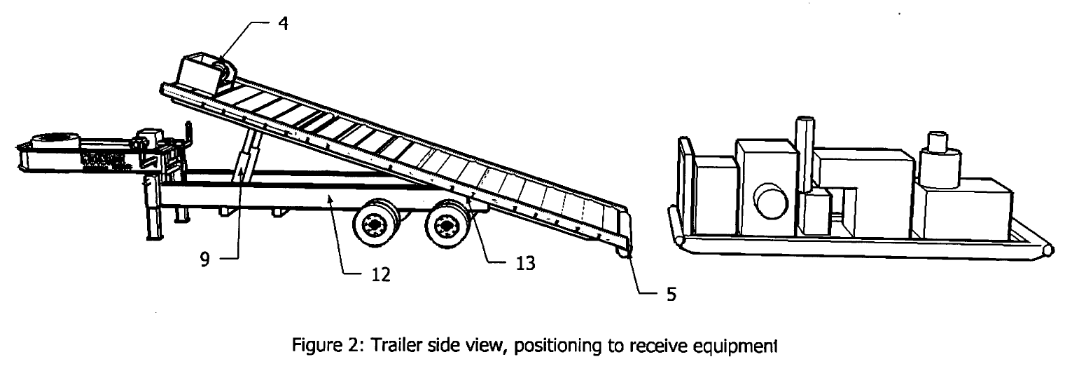

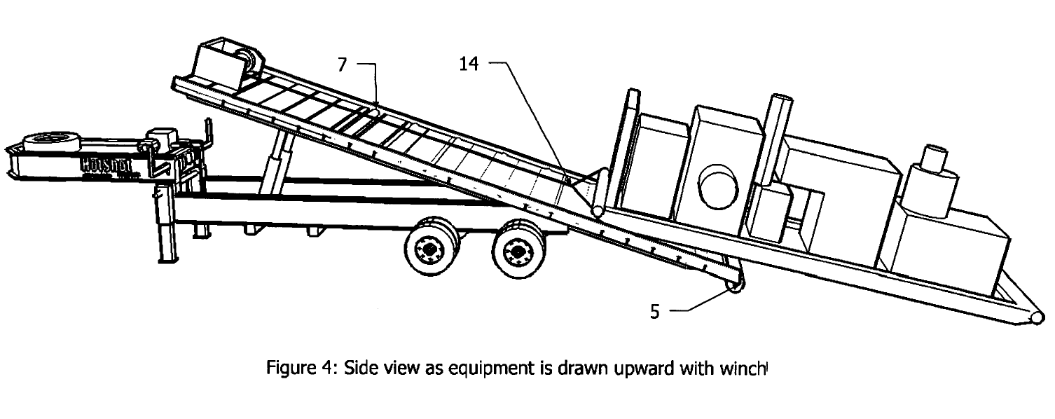

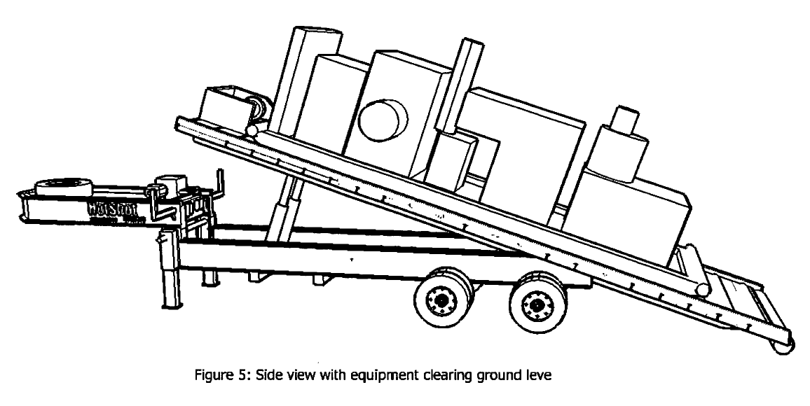

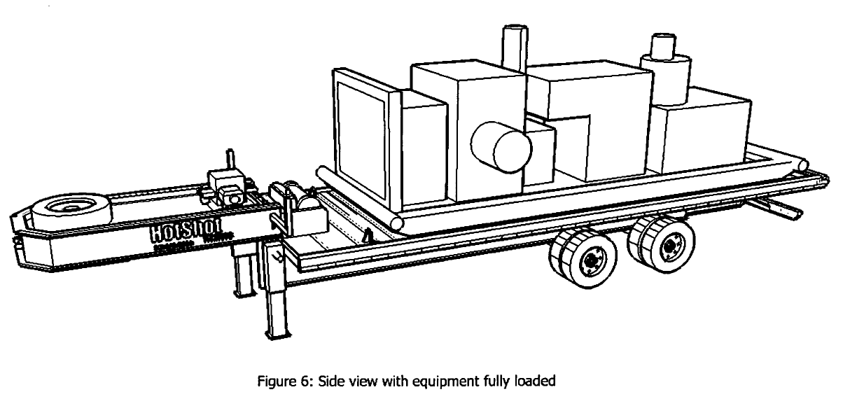

A typical operational sequence would be:
1. Backing up the trailer system to a position close to the leading edge of the base of the equipment to be loaded.
2. Raising the front edge of the trailer surface such that the trailing edge of the trailer surface is at or near ground level. FIG. 2.
3. Attaching the winch cable to the equipment.
4. Engaging the power winch to pull the equipment up and over the receiving roller at the rear edge of the trailer surface. FIG. 4.
5. Continuing to pull the equipment up and onto the trailer surface until the rear edge of the equipment clears the edge roller. FIG. 5.
6. Lowering the tilted surface to a horizontal position. FIG. 6.
7. Continuing to engage the power winch to pull the equipment over the rollers until the leading edge of the equipment contacts the steel stop blocks located toward the front edge of the trailer surface.
8. Securing the load with additional tie downs as needed.
9. Transporting the equipment to its destination.
10. Positioning the trailer system at the new operational location.
11. Reversing steps 1 through 7.

1. The invention claimed is: A system for loading, transporting, positioning and unloading large, heavy equipment to and from nontraditional worksites and locations.

2. The system according to claim 1 further comprising a goose neck flatbed trailer with a dual tandem over-the-road suspension system.

3. The system according to claim 2 further comprising a flatbed trailer surface that can be titled upward by means of dual hydraulic cylinders for the purpose of loading/unloading equipment from/to ground level.

4. The system according to claim 3 further comprising a powered winch and associated cabling and attachment hardware for the purpose of pulling up and lowering down the intended equipment.

5. The system according to claim 3 further comprising a flatbed surface embedded with several heavy duty steal rollers for the purpose of allowing the equipment to ‘roll’ across the flatbed surface.

6. The system according to claim 3 further comprising a larger heavy duty steel roller attached to the trailing edge of the flatbed surface for the purpose of receiving the equipment and delivering the equipment at ground level.

7. The system according to claim 3 further comprising a set of two steel stop blocks for the purpose of limiting the extent to which equipment may traverse toward the front edge of the trailer's flatbed surface.

8. The system according to claim 1 further comprising an electronic control system and associated hydraulic components for the purpose of controlling both the tilting flatbed surface angle and the powered winch.

9. The system according to claim 8 further comprising a wireless remote control box for the purpose of allowing the operator to freely move around the system and maintain a safe distance from the loading/unloading operation(s).

10. A method of loading, transporting, positioning and unloading certain large, heavy equipment to and from nontraditional worksites and locations.

11. The method according to claim 10 further comprising the step of backing the trailer up near the leading edge of the equipment to be loaded.

12. The method according to claim 10 further comprising the step of tilting the front edge of the flatbed trailer surface upward until the rear edge of the trailer surface is at or near ground level.

13. The method according to claim 10 further comprising the step of attaching the winch cable to the equipment.

14. The method according to claim 10 further comprising the step of engaging the powered winch so as to pull the equipment up and onto the trailer's larger end roller.

15. The method according to claim 10 further comprising the step of continuing to operate the powered winch to draw the equipment onto the surface of the trailer until the trailing edge of the equipment clears the large end roller.

16. The method according to claim 10 further comprising the step of lowering the tilted flatbed surface back to a horizontal position.

17. The method according to claim 10 further comprising the step of operating the winch to pull or ‘roll’ the equipment across the embedded steal rollers until the equipment contacts the steel stop blocks.

18. The method according to claim 10 further comprising the step of unloading the equipment by first backing up the trailer to an exact desired position for the trailing edge of the equipment.

19. The method according to claim 18 further comprising the step of tilting the front edge of the trailer surface until the large rear roller is at or near ground level.

20. The method according to claim 18 further comprising the step of operating the powered winch to lower the equipment until the edge of the equipment clears the rear roller and contacts the ground.

21. The method according to claim 18 further comprising the step of slowly pulling the trailer forward and releasing the winch cable so as to allow the equipment to roll off of the flatbed trailer surface to a horizontal position at ground level.

22. The method according to claim 18 further comprising the step of releasing the winch cable.
